(19) United States
(12) Patent Application Publication
(10) Pub. No.: US 2025/0201966 A1
(43) Pub. Date: Jun. 19, 2025

(54) IMMERSION THERMAL MANAGEMENT SYSTEMS FOR TRACTION BATTERY PACKS

(71) Applicant: FORD GLOBAL TECHNOLOGIES, LLC, Dearborn, MI (US)

(72) Inventors: Nathan Lee, Novi, MI (US); Wen Dai, Northville, MI (US); Chulheung Bae, Troy, MI (US); Adam Denlinger, Saline, MI (US)

(21) Appl. No.: 18/544,563

(22) Filed: Dec. 19, 2023

(51) Int. Cl. H01M 10/6568; B60L 50/60; H01M 10/613; H01M 10/625; H01M 50/211

(52) U.S. Cl. CPC H01M 10/6568; B60L 50/60; H01M 10/613; H01M 10/625; H01M 50/211; H01M 2220/20

(57) ABSTRACT

Immersion thermal management systems are provided for managing thermal energy in a traction battery pack. An exemplary immersion thermal management system may utilize an edge cooling scheme in which a coolant contacts minor side surfaces (e.g., top, bottom, and ends) of battery cells of the traction battery pack but does not flow across major side surfaces (e.g., faces) of the battery cells. The edge cooling scheme provides adequate cooling without adding volume and mass to the traction battery pack.

### TECHNICAL FIELD

This disclosure relates generally to traction battery packs, and more particularly to immersion thermal management systems for managing thermal energy levels within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a cell stack including a first battery cell having a first face, a second face, a first end, a second end, a top side, and a bottom side. An immersion thermal management system is configured to circulate a coolant along a coolant flow path that directly contacts the first end, the second end, the top side, and the bottom side but does not directly contact the first face or the second face.

In a further non-limiting embodiment of the foregoing traction battery pack, the coolant is a non-conductive coolant.

In a further non-limiting embodiment of either of the foregoing traction battery packs, the non-conductive coolant is a dielectric fluid.

In a further non-limiting embodiment of any of the foregoing traction battery packs, the first face and the second face establish major side surfaces of the first battery cell, and the first end, the second end, the top side, and the bottom side establish minor side surfaces of the first battery cell.

In a further non-limiting embodiment of any of the foregoing traction battery packs, the coolant directly contacts the minor side surfaces but does not directly contact the major side surfaces.

In a further non-limiting embodiment of any of the foregoing traction battery packs, a tab terminal projects outwardly from one of the minor side surfaces.

In a further non-limiting embodiment of any of the foregoing traction battery packs, the coolant flow path extends through a first compartment that extends between the top side of the first battery cell and a first portion of a support structure of the cell stack.

In a further non-limiting embodiment of any of the foregoing traction battery packs, the coolant flow path extends through a second compartment that extends between the bottom side of the first battery cell and a second portion of the support structure of the cell stack.

In a further non-limiting embodiment of any of the foregoing traction battery packs, the coolant flow path extends through a third compartment that extends between the first end of the first battery cell and a third portion of the support structure of the cell stack.

In a further non-limiting embodiment of any of the foregoing traction battery packs, the coolant flow path extends through a fourth compartment that extends between the second end of the first battery cell and a fourth portion of the support structure of the cell stack.

In a further non-limiting embodiment of any of the foregoing traction battery packs, the cell stack includes a second battery cell that is held in compression against the first battery cell.

In a further non-limiting embodiment of any of the foregoing traction battery packs, a third face of the second battery cell is received in direct contact with either the first face or the second face of the first battery cell.

A method according to another exemplary aspect of the present disclosure includes, among other things, immersion cooling a plurality of battery cells of a cell stack of a traction battery pack. During the immersion cooling, a coolant is directed across minor side surfaces of the plurality of battery cells but is not directed across major side surfaces of the plurality of battery cells.

In a further non-limiting embodiment of the foregoing method, each battery cell of the plurality of battery cells includes a first face, a second face, a first end, a second end, a top side, and a bottom side.

In a further non-limiting embodiment of either of the foregoing methods, the first face and the second face establish the major side surfaces of the battery cell, and the first end, the second end, the top side, and the bottom side establish the minor side surfaces of the battery cell.

In a further non-limiting embodiment of any of the foregoing methods, the coolant is a non-conductive coolant.

In a further non-limiting embodiment of any of the foregoing methods, the non-conductive coolant is a dielectric fluid.

In a further non-limiting embodiment of any of the foregoing methods, the immersion cooling includes directing the coolant through a compartment disposed between the plurality of battery cells and a support structure of the cell stack.

In a further non-limiting embodiment of any of the foregoing methods, the compartment extends between a top side or a bottom side of the plurality of battery cells and the support structure.

In a further non-limiting embodiment of any of the foregoing methods, the compartment extends between a first end or a second end of the plurality of battery cells and the support structure.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a traction battery pack of the electrified vehicle of FIG. 1.

FIG. 3 illustrates a cell stack of the traction battery pack of FIG. 2.

FIG. 4 is a cross-sectional view through section 4-4 of FIG. 2 and schematically illustrates a coolant flow path of an immersion thermal management system of the traction battery pack.

### DETAILED DESCRIPTION

This disclosure details immersion thermal management systems for managing thermal energy in a traction battery pack. An exemplary immersion thermal management system may utilize an edge cooling scheme in which a coolant contacts minor side surfaces (e.g., top, bottom, and ends) of battery cells of the traction battery pack but does not contact major side surfaces (e.g., faces) of the battery cells. The edge cooling scheme provides adequate cooling without adding volume and mass to the traction battery pack. These and other features are discussed in greater detail in the following paragraphs of this detailed description.

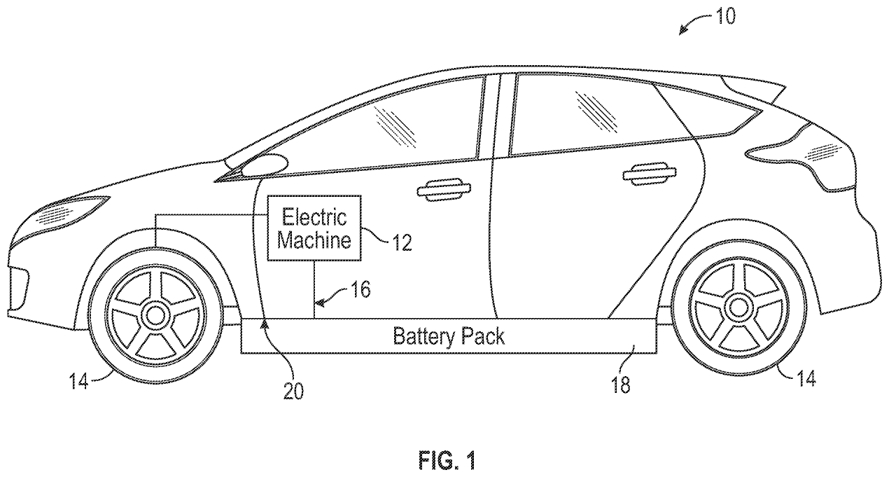

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

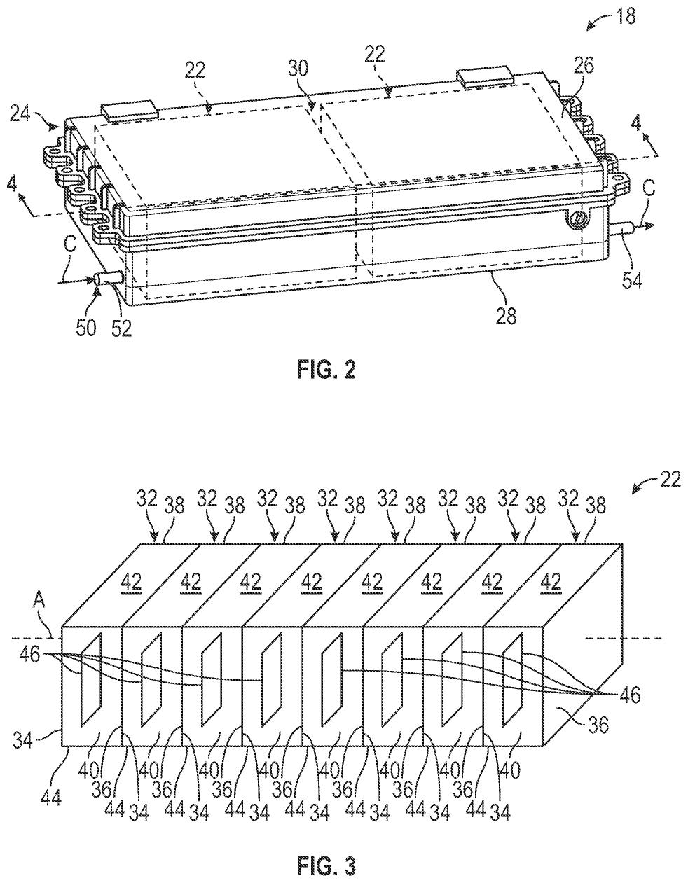

FIGS. 2, 3, and 4 illustrate additional details associated with the traction battery pack 18 of the electrified vehicle 10. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components (e.g., busbars, control modules and other electronics, etc.) of the traction battery pack 18. The size, shape, and configuration of the enclosure assembly 24 may vary within the scope of this disclosure.

Each cell stack 22 may include a plurality of individual battery cells 32 (see FIG. 3). The battery cells 32 store and supply electrical power for powering various components in order to support the electric propulsion of the electrified vehicle 10.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure.

Although a specific number of cell stacks 22 and battery cells 32 are illustrated in the various figures of this disclosure, the traction battery pack 18 could include any number of the cell stacks 22, with each cell stack 22 having any number of individual battery cells 32.

Each battery cell 32 may include a first face 34, a second face 36 opposite the first face 34, a first end 38, a second end 40 opposite the first end 38, a top side 42, and a bottom side 44 opposite the top side 42. The first face 34 and the second face 36 establish major side surfaces of the battery cells 32, and the first end 38, the second end 40, the top side 42, and the bottom side 44 establish minor side surfaces of the battery cell 32. The first face 34 and the second face 36 therefore exhibit a greater surface area than any of the first end 38, the second end 40, the top side 42, and the bottom side 44.

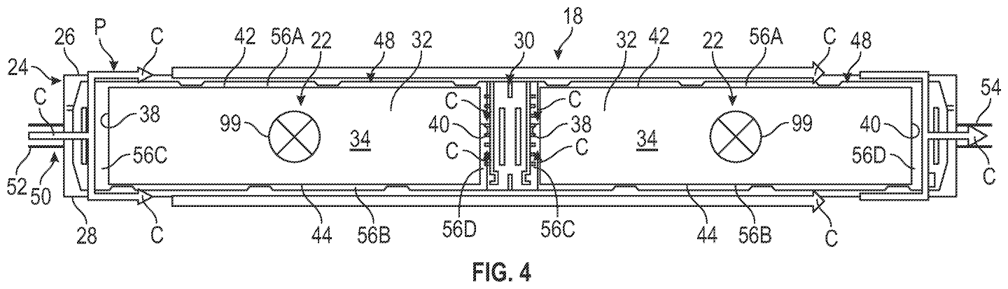

The battery cells 32 of each cell stack 22 may be stacked side-by-side relative to one another along a cell stack axis A (see FIG. 3). The battery cells 32 may be arranged such that the faces 34, 36 of one battery cell 32 are in direct contact with one of the faces 34 or 36 of a neighboring battery cell 32 of the cell stack 22. The battery cells 32 may be held in compression relative to one another within the cell stack 22 to provide the face-to-face cell arrangement. The compression may be applied by a support structure 48 (see FIG. 4) of the cell stack 22, for example. However, other configurations are contemplated within the scope of this disclosure. The support structure 48 may include any combination of plates, walls, crossmembers, beams, bindings, etc.

A tab terminal 46 may project outwardly from each of the first end 38 and the second end 40 of the battery cells 32. The battery cells 32 may thus be considered to be “side-oriented” within the cell stacks 22. The tab terminals 46 may be connected to busbars (not shown) in order to electrically connect the battery cells 32 of each cell stack 22.

Thermal energy levels within the battery cells 32 of the cell stacks 22 can increase as the electrified vehicle 10 is operated. An immersion thermal management system 50 can be employed for managing the thermal energy levels of the battery cells 32, cell stacks 22, and other areas of the traction battery pack 18. The immersion thermal management system 50 can be used to cool the battery cells 32 of the cell stacks 22. In some implementations, the immersion thermal management system 50 could also be used to heat the battery cells 32 of the cell stacks 22.

The immersion thermal management system 50 can deliver a coolant C to the interior area 30 of the traction battery pack 18 through an inlet 52. The coolant C can fill one or more open areas within the interior area 30 such that the battery cells 32 are immersed in, and directly contacted by, the coolant C within the traction battery pack 18. The coolant C can take on thermal energy from the battery cells 32 of the cell stacks 22 and other components of the traction battery pack 18 for managing thermal energy levels.

The coolant C may exit the traction battery pack 18 through an outlet 54. The coolant C can then move to a thermal energy exchange device (not shown), such as a heat exchanger, where thermal energy can be transferred from the coolant C. A pump (not shown) can be operated to selectively circulate the coolant C between the traction battery pack 18 and the thermal energy exchange device.

The coolant C may be a dielectric fluid or another type of non-conductive fluid (e.g., oil) that is designed for immersion cooling the battery cells 32 of the cell stacks 22. However, other non-conductive fluids may also be suitable, and the actual chemical make-up and design characteristics (e.g., dielectric constant, maximum breakdown strength, boiling point, etc.) may vary depending on the environment the traction battery pack 18 is to be employed within. Unlike the conductive glycol often utilized within known traction battery pack cold plate systems, the coolant C received inside the immersion cooled cell stacks 22 of this disclosure allows for direct contact with the battery cells 32 and other electrified components without causing electrical shorts. The exemplary immersion thermal management system 50 therefore enables high rate charging and discharging and allows for high load demands without increasing the hardware size of the cell stacks 22.

Referring now primarily to FIG. 4, the immersion thermal management system 50 may be configured to communicate the coolant C along a coolant flow path P that extends through various compartments 56 provided within the interior area 30 of the traction battery pack 18. Each compartment 56 may establish an open space for receiving the coolant C in a manner that permits direct contact with select portions of the battery cells 32. For example, first compartments 56A may extend between top sides 42 of the battery cells 32 of each cell stack 22 and a portion of the support structure 48 of the cell stack 22, second compartments 56B may extend between the bottom sides 44 of the battery cells 32 of each cell stack 22 and a portion of the support structure 48 of the cell stack 22, third compartments 56C may extend between the first ends 38 of the battery cells 32 of each cell stack 22 and a portion of the support structure 48 of the cell stack 22, and fourth compartments 56D may extend between the second ends 40 of the battery cells 32 of each cell stack 22 and a portion of the support structure 48 of the cell stack 22.

The coolant flow Path P may extend through each of the compartments 56A-56D, and thus the coolant C may be circulated through or may at least partially fill each compartment 56A-56D. The coolant C can therefore directly contact the minor side surfaces (and the tab terminals 46) of the battery cells 32 without directly contacting the major side surfaces of the battery cells 32. Due to the compression applied across each cell stack 22, the coolant C is substantially prevented (as schematically illustrated by symbol 99) from directly contacting the first and second faces 34, 36 of the battery cells 32. The immersion thermal management system 50 is therefore considered to provide an edge cooling scheme as opposed to a face cooling scheme.

The exemplary immersion thermal management systems of this disclosure are configured to edge cool the minor side surfaces of battery cells located inside a traction battery pack. The major side surfaces of the battery cells are not directly cooled. The edge cooling designs provide adequate cooling without adding volume and mass to the traction battery pack.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a cell stack including a first battery cell having a first face, a second face, a first end, a second end, a top side, and a bottom side; and
an immersion thermal management system configured to circulate a coolant along a coolant flow path that directly contacts the first end, the second end, the top side, and the bottom side but does not directly contact the first face or the second face.

2. The traction battery pack as recited in claim 1, wherein the coolant is a non-conductive coolant.

3. The traction battery pack as recited in claim 2, wherein the non-conductive coolant is a dielectric fluid.

4. The traction battery pack as recited in claim 1, wherein the first face and the second face establish major side surfaces of the first battery cell, and the first end, the second end, the top side, and the bottom side establish minor side surfaces of the first battery cell.

5. The traction battery pack as recited in claim 4, wherein the coolant directly contacts the minor side surfaces but does not directly contact the major side surfaces.

6. The traction battery pack as recited in claim 5, comprising a tab terminal that projects outwardly from one of the minor side surfaces.

7. The traction battery pack as recited in claim 1, wherein the coolant flow path extends through a first compartment that extends between the top side of the first battery cell and a first portion of a support structure of the cell stack.

8. The traction battery pack as recited in claim 7, wherein the coolant flow path extends through a second compartment that extends between the bottom side of the first battery cell and a second portion of the support structure of the cell stack.

9. The traction battery pack as recited in claim 8, wherein the coolant flow path extends through a third compartment that extends between the first end of the first battery cell and a third portion of the support structure of the cell stack.

10. The traction battery pack as recited in claim 9, wherein the coolant flow path extends through a fourth compartment that extends between the second end of the first battery cell and a fourth portion of the support structure of the cell stack.

11. The traction battery pack as recited in claim 1, wherein the cell stack includes a second battery cell that is held in compression against the first battery cell.

12. The traction battery pack as recited in claim 11, wherein a third face of the second battery cell is received in direct contact with either the first face or the second face of the first battery cell.

13. A method, comprising:
immersion cooling a plurality of battery cells of a cell stack of a traction battery pack,
wherein, during the immersion cooling, a coolant is directed across minor side surfaces of the plurality of battery cells but is not directed across major side surfaces of the plurality of battery cells.

14. The method as recited in claim 13, wherein each battery cell of the plurality of battery cells includes a first face, a second face, a first end, a second end, a top side, and a bottom side.

15. The method as recited in claim 14, wherein the first face and the second face establish the major side surfaces of the battery cell, and the first end, the second end, the top side, and the bottom side establish the minor side surfaces of the battery cell.

16. The method as recited in claim 13, wherein the coolant is a non-conductive coolant.

17. The method as recited in claim 16, wherein the non-conductive coolant is a dielectric fluid.

18. The method as recited in claim 13, wherein the immersion cooling includes directing the coolant through a compartment disposed between the plurality of battery cells and a support structure of the cell stack.

19. The method as recited in claim 18, wherein the compartment extends between a top side or a bottom side of the plurality of battery cells and the support structure.

20. The method as recited in claim 18, wherein the compartment extends between a first end or a second end of the plurality of battery cells and the support structure.
